(19) United States
(12) Patent Application Publication
(10) Pub. No.: US 2026/0360276 A1
(43) Pub. Date: Nov. 12, 2026

(54) EDUCATIONAL QUANTUM LAB CHIP

(71) Applicant: University of Copenhagen, Copenhagen K (DK)

(72) Inventors: Anasua Chatterjee, Delft (NL); Saulius Vaitiekenas, Copenhagen Ø (DK); Charles Marcus, Seattle, WA (US); Ferdinand Kuemmeth, Copenhagen Ø (DK)

(73) Assignee: University of Copenhagen, Copenhagen K (DK)

(21) Appl. No.: 19/153,448

(22) PCT Filed: Feb. 7, 2024
(86) PCT No.: PCT/EP2024/053079

§ 371 Date: Aug. 4, 2025

(30) Foreign Application Priority Data
Feb. 7, 2023 (EP) 23155329.8

(51) Int. Cl. G09B 19/00

(52) U.S. Cl. CPC G09B 19/0053

(57) ABSTRACT

A quantum lab chip for quantum experiments comprises a plurality of different device regions. Each device region comprises quantum electronic devices requiring similar experimental conditions. At least a first device region may comprise at least one semiconductor device, at least a second device region may comprise at least one superconductor on insulator device, and at least a third device region may comprise hybrid semiconductor-superconductor devices.

### CROSS-REFERENCE TO RELATED APPLICATIONS

The present application is the national phase entry of International Patent Application No. PCT/EP2024/053079, filed Feb. 7, 2024, which claims priority to European Patent Application No. 23155329.8 filed Feb. 7, 2023, the entire contents of both are hereby incorporated by reference.

### FIELD OF DISCLOSURE

The present disclosure relates to a chip comprising devices for quantum electronic experiments for educational purposes.

### BACKGROUND

Quantum electronic chips are based on electronic devices that make use of the principles of quantum mechanics to perform electronic operations.

In the educational field of quantum electronics, quantum electronic chips teach students about the core principles of quantum mechanics and its applications in modern technology. Educational quantum electronic chips are typically fabricated by the students at university facilities to be used in the classroom or laboratory. In addition, there is often a lack of accompanying software and educational materials to help students understand how the chip works and how to control it.

An example of an educational quantum electronic chip is the IBM Q Experience, which is a cloud-based solution that allows students to access and experiment with a real quantum computer. However, access to these tools are often limited and costly for educational institutions. In addition, students do not have physical access the quantum electronic chip to study the morphological structure and architecture of the devices comprised on the chip.

Due to the recent gain of interest in the quantum computing field, it is estimated that a lack of skilled people and experts in the field will become a bottleneck in the development of the new technologies emerging from quantum electronics. The required “knowledge infrastructure” to develop new quantum technologies will likely not be supplied by the standard higher degree education paths as the main source of skilled and experts in the field. Examples of fields stemming from quantum electronics are quantum computing, quantum key distribution, and quantum cryptography.

Hence, any additional educational tool for teaching and learning quantum electronics are valuable tools for the correct development of the emerging field of quantum electronics and related technologies stemming from it.

### SUMMARY

Considering the prior art described above, it is an object of the present disclosure to provide a quantum electronics chip for educational purposes that may be tailored to meet the particular requirements needed by any institution teaching quantum electronics or its derived technologies. The needed requirements of such quantum electronics chip may be, e.g., robustness, reproducibility, and redundancy.

The object can be achieved by means of a quantum lab chip for quantum experiments. Such a chip comprises a plurality of device regions. A first device region comprises at least one semiconductor device for performing semiconductor property measurements. A second device region comprises at least one superconductor-on-insulator device for performing superconductor property measurements. By provision of the first and second device regions, the quantum lab chip may facilitate teaching quantum electronics or its derived technologies in a relatively convenient manner, as only a single chip needs to be mounted and, e.g., cooled down in order to conduct experiments on both the semiconductor device of the first region, and the superconductor-on-insulator device of the second region. Moreover, present embodiments allow, potentially simultaneously, conducting quantum experiments on the semiconductor device of the first region, and/or the superconductor-on-insulator device of the second region.

In some embodiments, the quantum lab chip comprises a third device region comprising at least one hybrid semiconductor-superconductor device. By provision of the third device region, the quantum lab chip may to an even larger degree facilitate teaching quantum electronics or its derived technologies. Moreover, by including the third device region, the quantum lab chip is configured to conduct measurements also on a semiconductor-superconductor device, while, potentially simultaneously, conducting quantum experiments on the semiconductor devices of the first region, and/or the superconductor-on-insulator device of the second region.

In some embodiments, the quantum lab chip comprises additional device regions, each additional device region comprising different quantum devices from the devices comprised in the first or second regions, or a selected combination of quantum electronic devices comprised in one or more regions. For example, a fourth device region may comprise exclusively devices from the first or second region which may require the use of magnetic field. Another example of an additional region comprising devices from the first or second region may require the application of a particular temperature, such as liquid nitrogen temperature 77 K, room temperature or millikelvin temperatures.

Thus, it is possible to improve the performance of the measured quantum electronic devices by locating in a same region depending on the required physical requirements of each device. Devices requiring similar physical conditions may be located in the same region, which makes it easier to provide the required physical conditions to devices in that region and/or other regions. Moreover, if, e.g., devices in the first region require a first set of physical conditions during experiments, such as, e.g., a magnetic field with variable field strength, the first region can be designed to facilitate provision of such magnetic field, while the second region need not be able to facilitate provision of such magnetic field. The arrangement of quantum electronic devices requiring similar physical conditions of present embodiments may further minimize the cross-talk and interferences between devices.

Advantageously, the location of the quantum electronic devices comprised in a device region is designed to minimize the number of required contact lines to control the quantum electronic devices. The flip chip packaging technique may be used, allowing to inter-connect devices and thus minimizing the number of required contact lines.

In some embodiments, the device regions comprise a plurality of identical or at least similar devices, such as at least 5, 10 or at least 100 identical or at least similar devices. By identical or at least similar devices is meant devices designed to probe the same or similar physical properties of the device. The identical or at least similar devices may thus be one type of devices selected from the group of: field effect transistor, Drude conductivity, two-dimensional electron gas in heterostructure, one dimensional ballistic transport, quantum point contact, Coulomb blockade, single-electron transistors, single-electron turnstile, Aharonov Bohm effect, electron weak localization, electron antilocalization, coupled quantum dots, single-electron charge sensing, single-electron tunnelling, sequential electron tunnelling, Pauli blockade, spin-to-charge conversions, automatic gate-voltage tuning or spin qubits. This allows the quantum lab chip to be more robust against device failures originated during the fabrication of the chip, to overcome a larger number of eventual failures originated during experimental measurement of the properties of the quantum electronic devices comprised on the chip or to perform statistical deviations.

Preferably, a number of protective features against electrostatic discharges are located on the chip to protect the quantum electronic devices before and during its use. Such features may be for example protective diodes or a temperature dependent resistive layer.

In present context, the term “region” is to be understood as a confinement in space. More particularly a region defines—in case the quantum lab chip comprises a planar substrate—a confined area in a plane parallel with the planar extent of the planar substrate. If, e.g., the first region comprises two semiconductor devices, and the second region comprises a superconductor-on-insulator device, the area on the chip occupied by the two semiconductor devices and the space between them may constitute at least part of the first region, while the area on the chip occupied by the superconductor-on-insulator device may constitute at least a part of the second region. Moreover, a “region” may be understood as any confined area on the chip comprising at least one type of device.

The first, second, third, and/or fourth regions are preferentially arranged in a non-overlapping manner. In such embodiments, if, e.g., the first and second regions are arranged in a non-overlapping manner, the first region comprises two semiconductor devices and the second region comprises a superconductor-on-insulator device, then the superconductor-on-insulator device is arranged outside of the area on the chip occupied by the two semiconductor devices and the space between them constituting at least part of the first region.

### BRIEF DESCRIPTION OF THE DRAWINGS

The invention will in the following be described in greater detail with reference to the accompanying drawings:

FIG. 1 is a schematic view of a design for an embodiment of the quantum lab chip, wherein each area A1 to A4 comprises a number of quantum electronic devices;

FIG. 2 is an optical image of an embodiment of the quantum lab chip connected with electrical connections to a mother board chip holder;

FIG. 3 is a schematic view of an embodiment of the chip flip technique of contacting the contact lines of the quantum lab chip to the contact bumps from the underneath package substrate chip holder; and

FIG. 4 is a schematic view of an embodiment of the quantum lab chip located on a chip holder and electrical connections connecting the different parts of the chip with the bonding pads, wherein the electrical connections are designed using a multiplexer MUX chip.

### DETAILED DESCRIPTION

The present disclosure relates to a quantum lab chip for quantum experiments. This chip is intended to be robust against failures, comprising, e.g., redundant quantum electronic devices and having a circuit design that may optimize the space on the chip and minimize the cross-talk between nearby devices. These features may be of particular relevance for, e.g., educational use, wherein several experiments requiring different experimental conditions are performed repetitively, typically by users non-expert in the field.

In some embodiments, the quantum lab chip comprises a plurality of different device regions. Additionally, in some embodiments, each device region comprises a plurality of quantum electronic devices requiring similar experimental conditions or comprised by the same device physical platform. Said experimental conditions may be for example a required temperature of the chip, the used magnetic field, the voltage and frequency of the signals used to control the devices or performing measuring techniques that require specific measuring tools. Said device physical platform may be for example semiconductor, superconductor or semiconductor-superconductor device platforms. Preferably, the quantum lab chip is designed and fabricated such that it can be loaded into cryostats such as a multistage cryostat like a dilution refrigerator.

In some embodiments, at least a first device region comprises at least one semiconductor device, preferably selected from the group of: field effect transistor, Drude conductivity, two-dimensional electron gas in heterostructure, one dimensional ballistic transport, quantum point contact, Coulomb blockade, single-electron transistors, single-electron turnstile, Aharonov Bohm effect, electron weak localization, electron antilocalization, coupled quantum dots, single-electron charge sensing, single-electron tunnelling, sequential electron tunnelling, Pauli blockade, spin-to-charge conversions, automatic gate-voltage tuning or spin qubits.

The devices may be used to extract physical parameters of the device comprising charge carriers, such as electrons or holes.

A field effect transistor device may be used to understand the different doping regions in the device and the role of the terminals source, drain and gate terminals comprised by the device. Characteristic I/V curves and the pinch-off voltage may be extracted for a given field effect transistor.

Drude conductivity semiconductor devices may be used to extract parameters of the diffusive trajectory of electrons, the scattering time, the drift velocity of electrons, the electron effective mass and their dependency with temperature and magnetic field.

Two dimensional electron gas devices may be used to extract the electron mobility of the confined electrons in a semiconductor thin film. Different semiconductor stacks comprising a heterostructure may be used as two dimensional electron gases. Different measurements may be performed at different temperatures and applying static or varying magnetic fields.

One dimensional ballistic transport devices may be used to extract a charge carrier mean free path, quantum conductance or scattering time of charge carriers on predominantly 1D devices. Semiconductor nanowires or carbon nanoribbons may be comprised in the one dimensional ballistic transport devices.

Quantum point contact devices may comprise narrow transport channels between two contacts. This may be achieved either by design means, such as lithographically designed, or by using quasi-1D nanostructures such as nanowires or nanoribbons. Quantum conductance as a function of the applied voltage and the shape of the conductance plateau may be extracted for understanding the quality of the transport channel narrow constriction in the transport channel. Typically, the size of the constriction is comparable to the wavelength of the employed charge carrier.

Coulomb blockade devices may be fabricated by generating a small region on a semiconductor, normal conductor or superconductor, comparable to the wavelength of the charge carriers, e.g., as a quantum dot. Capacitance or conductance variation depending on the applied voltage may be extracted from Coulomb blockade devices.

Additionally, several quantum dots may be coupled in series, allowing to control single electrons in a series of concatenated quantum dots.

Single-electron transistor devices may be used for performing coulomb blockade or single electron transmission experiments. Such a device generally comprises drain and source electrodes, connected by a tunnel junction controlled by a gate electrode, which is capacitively connected to the quantum dot island comprised between both drain and source. Single electron transitions between electrodes, thermal excitation of electrons on the quantum dot or tunnelling resistance experiments may be performed on the single-electron transistor device. A single-electron turnstile, similarly to a single-electron transistor, comprises a quantum dot defined by two nearby electrodes wherein said electrodes comprise superconductors. Definition of the Ampere, single electron charge sensing or sequential electron tunnelling experiments may be realised with the single-electron turnstile device.

Aharonov-Bohm effect devices generally comprise semiconducting closed loops wherein a magnetic flux is generated inside the closed area of the loop. Aharonov-Bohm effect devices may be used on self-interference electron experiments, and/or electron interferometry with a magnetic field experiments.

Electron weak localization devices may be comprised in devices comprising a stripe of superconducting or semiconducting material wherein lateral contact gates are located on the sides of the stripe. Due to the quantum mechanical probability of an electron propagating in disordered materials through more than one available path, a net positive contribution is added to the resistance of the material due to the addition of all the possible scattering events for that electron. The calculation of the net positive contribution to resistance or the net negative contribution to resistance due to the spin-orbit coupling of an electron experiments may be realized with the electron weak localization device.

Pauli blockade devices may be experimentally realised by fabricating confining regions on a semiconductor or conductor material by using a plurality gate electrodes. In Pauli blockade devices, charge carrier transport through the quantum dots defined by the gates is blocked due to Pauli selection rules, even when energetically allowed.

Spin-to-charge conversions may be realised by quantum electronic devices capable of generating and detecting spins via spin to charge conversion. Examples of spin-to-charge devices may make use of the Rashba-Edelstein effect or comprise topological insulators.

Spin qubits may be defined on semiconductors, conductors or insulators using gate electrodes, wherein qubit operation experiments may be performed. Manual and automatic gate-voltage tuning may be realized on spin qubit devices.

The first device region comprises one, two, three or more of said types of semiconductor devices. Any combination of any the mentioned devices, or any other device comprising semiconductors as the main active region may be used in the first device region.

In another embodiment, at least a second device region comprises at least one superconductor on insulator device, preferably selected from the group of: superconducting microwave resonator, superconductor-insulator-superconductor Josephson junction, Meissner effect device, superconductor-insulator-normal metal junction, Fraunhofer interference device, SQUID device, or one or more superconducting qubits embedded in a microwave resonator.

Superconducting microwave resonators comprise for example superconducting devices comprising LC circuits or microwave cavities. Such device may be used with a static or alternating magnetic field. Superconducting microwave resonators may be used for example to extract frequency-multiplexed readout of cryogenic detector arrays.

Josephson junction devices comprise material stacks having superconductor-insulator-superconductor properties. Josephson junctions may be used to extract the supercurrent flowing between the superconducting islands or to measure the DC and AC Josephson effect.

Meissner effect devices comprise a superconducting region and an applied magnetic field. Said devices may be used to explore different superconducting properties of the superconductor under the magnetic field, such as perfect diamagnetism or superdiamagnetism.

Superconductor-insulator-normal metal junction devices comprise an island of superconductor material, an island of insulator material and an island of normal metal material. Said devices may be used to perform temperature reading experiments in the millikelvin range.

Fraunhofer interference devices comprise two superconducting islands separated by a semiconductor, such as Al superconducting islands separated by InAs. Said device may be used to perform experiments such as critical current dependency of the superconductor as a function of an applied magnetic field.

A superconducting quantum interference device (SQUID) comprise a loop-like superconducting region comprising a non-superconducting region in the center. Said device may be used to, e.g., detect extremely weak magnetic fields in the order of 10⁻¹⁰ T.

The second device region comprises one, two, three or more of said types of superconductor on insulator devices. Any combination of any the mentioned devices, or any other device comprising superconductors located on insulators as the main active region may be used in the second device region.

In some embodiments, at least a third device region comprises hybrid semiconductor-superconductor devices such as Andreev reflection or topological superconductivity devices like III-V semiconductor and superconductor heterostructures. Additional device regions may comprise any combination of devices from the first, second and third regions according to the particular educational requirements of the quantum lab chip. Additionally, device regions comprising the same number, distribution and type of quantum electronic devices may be repeated on different locations of the quantum lab chip.

Topological superconductivity devices comprise stacks of materials such as a III-V semiconductor and a standard type superconductor such as Al. Different combinations of materials may be used that collectively show topological superconductive properties. Experiments like Andreev reflections, Majorana Bound States or braiding operations may be performed using said devices.

The use of the previous devices is not limited to the described properties or experiments, and they may be used to explain additional concepts related to the nature of the devices or the type of physics that can be extracted from them.

The quantum electronic devices comprising the first, second and third device regions are known in the field of quantum electronics. The electronic properties, morphology, structural parameters and physics of said devices are described in detail in Thomas Ihn, Semiconductor Nanostructures: Quantum states and electronic transport, OUP Oxford, 2009, which is added as a reference to the present disclosure in its entirety.

In another embodiment, the quantum lab chip may comprises additional device regions comprising different quantum devices from the devices comprised in the first, second or third regions, or a selected combination of quantum electronic devices comprised in one or more regions. For example, a fourth device region may comprise exclusively devices from the first, second and third region which require the use of magnetic field. Another example of an additional region comprising devices from the first, second and third region may require the application of a particular temperature, such as liquid nitrogen temperature 77 K, room temperature or millikelvin temperatures.

Devices comprised in additional device regions may have at least one property in common, which may be a physical requirement or a particular intended educational purpose. Additional device regions may comprise a set of basic quantum electronic devices required for the learning of a particular educational curriculum. Said additional device regions may be replicated redundantly over a same quantum lab chip to allow a plurality of users to measure simultaneously said quantum electronic devices.

Typically, each device region is separated from each other by a distance of at least 10 μm, preferably at least 100 μm, more preferably more than 1 mm. The distance between different device regions should be sufficiently big to minimize cross-talk or interference between different device regions. For example, device regions comprising quantum electronic devices requiring magnetic field may be sufficiently separated from device regions comprising quantum electronic devices sensible to the presence of magnetic fields. Other relevant parameters affecting the distance between different device regions are, e.g., temperature, the use magnetic field, the voltage amplitude and frequency of the signals used to control the devices or performing measuring techniques, the requirement of specific measuring tools, the required number of lines needed to measure a type of quantum device, the type of required physical platform of a specific device (such as a 2D heterostructure, a 1D nanowire or a 3D super-stack of different materials of different composition) or the number and length of contact lines required to realize a particular device (such as requiring a resonator).

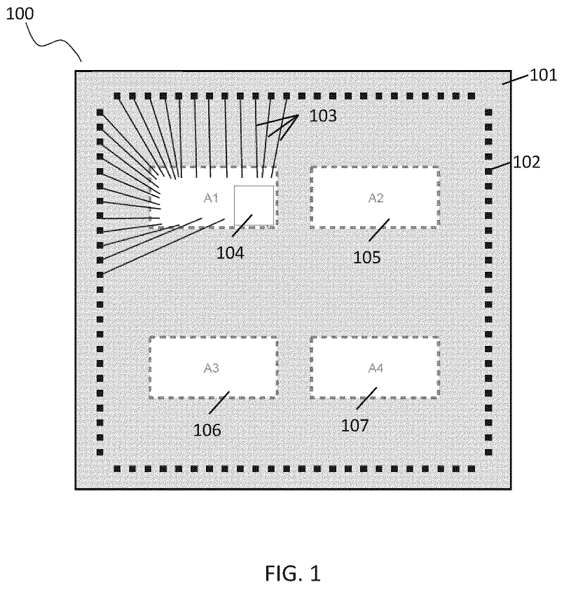

FIG. 1 shows a schematic view of a design for the quantum lab chip 100, wherein each area A1 to A4 comprises a number and type of quantum electronic devices. The chip is fabricated on a supporting substrate 101, wherein an array of contact pads are spread around the areas comprising the quantum electronic devices. The device areas 104, 105, 106 and 107 are schematically located on the surface and spreading along the quantum lab chip. Each device area comprises devices requiring similar experimental conditions. Other device areas may comprise a subset of devices from the other regions. Contact lines 103 are fabricated on the quantum lab chip to connect each device allowing its control and measurement. Contact pads 102 are distributed along the sides of the quantum lab chip to connect the contact lines with external connection lines, typically connected to a controlling PC unit.

In a preferred embodiment, at least one of the device regions comprises a plurality of identical devices, such as at least 5, 10 or at least 100 identical devices. The number of each identical devices may be different depending on the type of device, wherein a device may comprise a higher number of identical devices than other devices. The number of identical devices is designed based on a number of variables such as how reliable each device is to failures during operation, the statistical dispersion of results generated by each device, the sensibility of a device to ambient conditions (such as reactiveness to atmospheric moisture or oxygen), the failure probability of a quantum electronic device during loading/unloading operations on a cryostat, the failure probability of a quantum electronic device caused by electrostatic discharges during operation or inspection before loading on a cryostat or the number of users intended to be simultaneously measuring a quantum electronic device.

In some embodiments, each device region comprises at least one contact line connecting each device. Contact lines are deposited, fabricated and/or arranged on the quantum lab chip using cleanroom nanofabrication tools such as thin film metallic evaporation systems. Contact lines are designed on the quantum lab chip in order to minimize the required number of lines to allow a higher density of devices. Each device comprises the number of lines required to allow the complete control of the variables that define the state of the device, to control the evolution of the state of the device and to extract the state and any relevant variable of the device.

Preferably, the number of contact lines and their arrangement on the surface of the quantum lab chip is designed to minimize the contact line length and to increase the density of the number of contact lines per surface area. Contact lines may be shared between more than one quantum electronic devices.

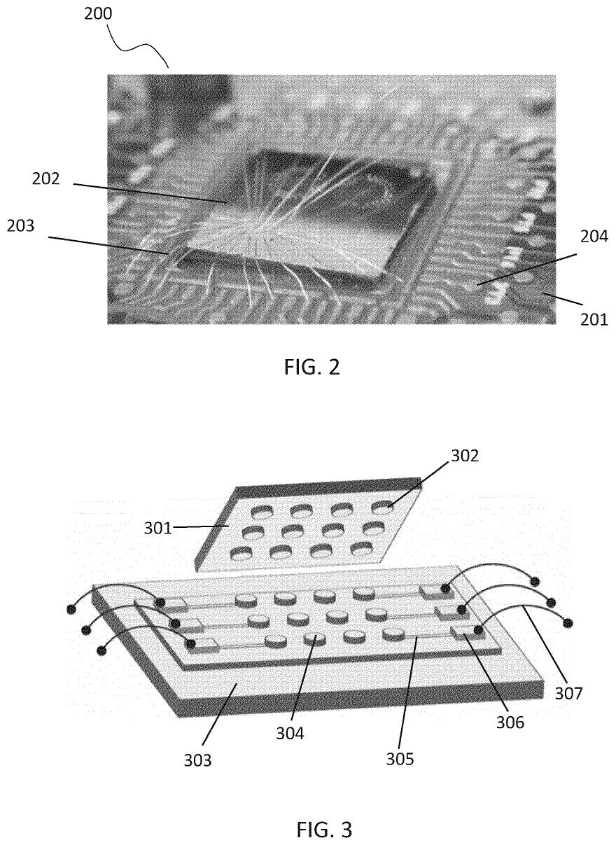

FIG. 2 shows an optical image of a quantum lab chip 200 glued on a motherboard 201. The substrate of the quantum lab chip 202 comprises the device areas containing the quantum electronic devices. In the shown embodiment, the quantum electronic devices are connected through gold contact lines 203 to the contact pads 204. The contact pads allow to connect each contact line to a computing unit capable of controlling the quantum electronic devices and allowing to measure their electronic properties. The motherboard 201 holding the quantum lab chip may be loaded in a cryostat refrigerator in order to vary the temperature of the quantum electronic devices and hence being able to measure their properties at different temperatures. The motherboard 201 is also compatible to measure the electronic properties of the quantum electronic devices at room temperature.

Contact lines connecting the quantum electronic devices on the quantum lab chip may be defined and arranged using traditional quantum chip gold contact lines deposited on the chip connecting the devices with the contact pads located in the outer part of the chip. The contact lines can be defined and arranged following the flip-chip packaging technique. A design of the contact lines combining simultaneously the metallic evaporation defined and flip-chip contact lines is possible.

In some embodiments, the at least one contact line is arranged following a flip-chip packaging technique. Flip-chip packaging technique allows to increase the density of quantum electronic devices defined on the quantum lab chip due to the specific design of the contact lines. In the flip-chip packaging technique the active area of a chip is facing down (“flipped”). Instead of comprising contact lines directly bonding the devices with the bonding pads, in this strategy the whole area of the chip may be used for interconnection purposes. Metal bumps of micrometric size are soldered on the surface of the chip allowing to connect the contact lines of the devices with the underneath chip comprising the interconnections. This packaging technique allows to fit a large number of quantum electronic device contact lines, while requiring a typically shorter length compared to the standard contact lines. Advantageously, this reduces undesired inductances created by standard contact lines.

FIG. 3 shows a schematic representation of a quantum lab chip 301 with contact lines arranged in flip-chip packaging configuration. Metal bumps 302 connect the parts of a quantum electronic device via a short contact line, not shown. The metal bumps 302 from the quantum lab chip can be placed in electrical contact with the metal bumps 304 located in the host carrying chip 303. The area from the host carrying chip 305 wherein the quantum lab chip 301 is located may comprise a material that may be insulating or conductive at room temperature. The contact pads 306 are located at the edges of the area 305 wherein contact lines 307 are bonded, allowing to connect each contact line to a computing unit capable of controlling the quantum electronic devices and allowing to measure their electronic properties.

The quantum lab chip may be fabricated with standard nanofabrication tools used in the fabrication of quantum electronic devices. Said tools may comprise the use of resistive polymers, lithography techniques such as electron beam or optical, etching techniques such as wet or dry etching, resistive polymer chemical developers or thin film evaporators.

In some embodiments, at least one contact line is connected to a multiplexer chip. Said multiplexer is located in a separate region adjacent to the device regions. In addition, the multiplexer chip may be connected to a control computing unit. The multiplexer chip may have a size comparable to a device region, such as few millimetres in size. The multiplexer may connect via up to thousands of metal bump bonds and routes on the host carrying bottom chip to a plurality of quantum lab chips. Quantum lab chips may be based on different platforms, for example quantum lab chip 1 could be a semiconducting chip based on GaAs, quantum lab chip 2 could host superconducting devices on insulating silicon, and quantum lab chip 3 could be a hybrid semiconductor-superconductor device chip based on InAs/Al. Frequency-domain and time-domain multiplexing may allow hundreds of users to perform experiments effectively simultaneously, wherein each user measures a different device (or multiple users operating the same device). The use of the multiplexer chip allows up to thousands of devices to be accessed using less than 96 signal channels.

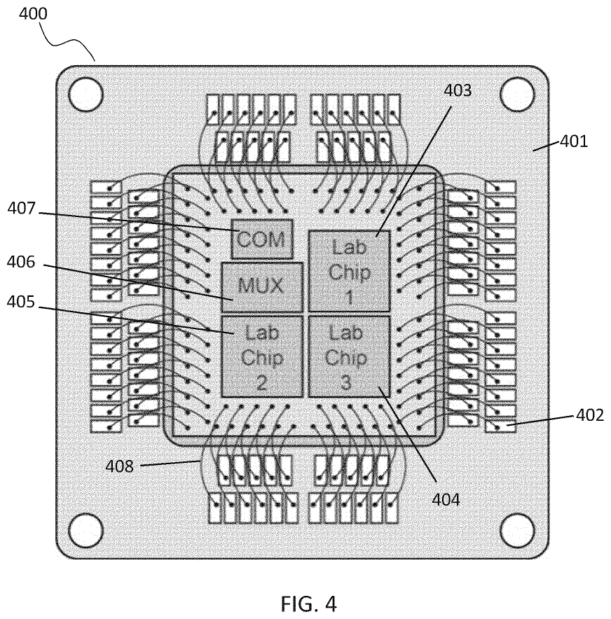

FIG. 4 shows a schematic view of the quantum lab chip 400 located on a chip holder 401. The quantum lab chip comprises a plurality of lab chips 403, 404 and 405, wherein each of the lab chips may comprise a different set of quantum electronic devices. Electrical connections 408 connecting the different parts of the chip with the bonding pads 402 and the contact lines required to control each quantum electronic device are designed using the multiplexer MUX 406 chip. A communication COM chip 407 is used to allow the communication and control of the multiplexer chip with an external control computing unit.

In some embodiments, each device region in a quantum lab chip comprises a surface of at least 1 mm², preferably at least 10 mm², more preferably at least 50mm². The size of each device region may be determined by the number of devices comprised in it, the location of the device region within the quantum lab chip, the maximum chip size allowed in the carrying host chip and the maximum sample size allowed by the cryostat refrigerator.

The device regions of the quantum lab chip are preferentially fabricated on a substrate, preferably selected from the group of semiconducting materials such as InAs, InP, InSb, GaAs, GaSb, AISb and InGaAs, or group IV elements such as Si or Ge, or dielectric materials such as sapphire. Additionally, the substrate may be a semiconductor heterostructure such as type IV semiconductors Ge/SiGe, type III-V semiconductors such as GaAs/InAs, type II-VI semiconductors or insulators. The substrate comprises a surface area of at least 5 mm², preferably at least 25 mm², more preferably at least 1cm 2 . The size of the substrate is enough to comprise a plurality of device regions and to locate the plurality of contact lines required to control the quantum electronic devices.

In some embodiments, the identical quantum electronic devices are separated by less than 50 μm, preferably less than 10 μm and more preferably less than 5 μm. The minimum distance between identical devices may be dictated by the required surface to locate the contact lines and the minimum distance to avoid cross talk between the devices. The identical devices requiring a magnetic field are separated preferably less than 50 μm, more preferably less than 10 μm, even more preferably less than 5 μm, the minimum distance to avoid cross talk between the devices. The distance between contact lines is at least 50 nm, preferably at least 100 nm or more preferably at least 300 nm or the minimum distance to avoid cross talk between the contact lines.

In some embodiments, the quantum lab chip comprises resistive connections configured to protect the chip from electrostatic discharges. The resistive connections comprise at least one a temperature dependent resistive layer. In particular, the resistive connections may comprise resistive paths between different regions of the chip to protect the chip from electrostatic discharges. Some of these resistive layers may have temperature dependent insulating properties so as to not affect device functionality at low temperature, while providing electrostatic discharge protection at and near room temperature. This feature allows to protect the quantum lab chip against undesired electrostatic discharges, making it robust during its inspections and preparation by the user.

The quantum lab chip may comprise at least one protective diode configured to protect the chip from electrostatic discharges. Said protective diode may be lithographically designed on each device comprising the chip and/or located on at least one end of at least one contact line.

The quantum lab chip may be assembled on a chip holder, facilitating convenient loading and unloading of the chip from cryostats and for the visual or microscopic inspection by the user. A chip holder may be a printed circuit board specifically designed to be loaded and measured in dilution refrigeration cryostats. In addition to the protection against electrostatic dischargers defined on the quantum lab chip, the chip holder board may comprise at least one element configured to protect the chip from electrostatic discharges.

A method of performing quantum experiments with the quantum lab chip for educational purposes, comprises the steps of providing one or more quantum lab chips as described in the present disclosure, cooling down the chip to a target cryogenic temperature using type of cryostat, such as a helium dilution refrigerator, measuring a number of quantum electronic devices located within the same device region potentially simultaneously, optionally obtaining statistical deviations of the measured properties by measuring identical or at least similar quantum electronic devices, and repeating the previous steps in quantum electronic devices from at least one other region. Additionally, the measurements may be performed on quantum electronic devices requiring similar physical conditions. Said similar physical conditions may be, e.g., constant magnetic field, a variable magnetic field and/or a predefined temperature.

The target cryogenic temperature is selected according to predefined requirements of the quantum experiment devices, such as room temperature, 77 K, 4 K or less than 1 K.

Measurements may be performed at fixed experimental conditions or while varying any of the experimental conditions.

### Items

1. a quantum lab chip for quantum experiments.
2. The chip of item 1, comprising a plurality of different device regions, each device region comprising quantum electronic devices requiring similar experimental conditions.
3. The chip according to any of the preceding items, wherein at least a first device region comprises at least one semiconductor device, preferably selected from the group of: field effect transistor, Drude conductivity, two-dimensional electron gas in heterostructure, one dimensional ballistic transport, quantum point contact, Coulomb blockade, single-electron transistors, single-electron turnstile, Aharonov Bohm effect, electron weak localization, electron antilocalization, coupled quantum dots, single-electron charge sensing, single-electron tunnelling, sequential electron tunneling, Pauli blockade, spin-to-charge conversions, automatic gate-voltage tuning or spin qubits.
4. The quantum lab chip of item 3, wherein the first device region comprises two, three or more of said types of semiconductor devices.
5. The chip according to any of the preceding items, wherein at least a second device region comprises at least one superconductor on insulator device, preferably selected from the group of: superconducting microwave resonator, superconductor-insulator-superconductor Josephson junction, Meissner effect device, superconductor-insulator-normal metal junction, Fraunhofer interference device, SQUID device, or one or more superconducting qubits embedded in a microwave resonator.
6. The quantum lab chip of item 5, wherein the second device region comprises two, three or more of said types of superconductor devices.
7. The chip according to any of the preceding items, wherein at least a third device region comprises hybrid semiconductor-superconductor devices such as Andreev reflection or topological superconductivity devices.
8. The chip according to any of the preceding items, wherein at least one of the device regions comprises a plurality of identical devices, such as at least 5, 10 or at least 100 identical devices.
9. The chip according to any of the preceding items, wherein a fourth device region comprises a combination of devices from the first, second and/or third regions.
10. The chip according to any of the preceding items, wherein each device region is separated of each other a distance of at least 10 μm, preferably at least 100 μm, more preferably more than 1 mm.
11. The chip according to any of the preceding items, wherein each device region comprise at least one contact line connecting each device.
12. The chip according to any of the preceding items, wherein the at least one contact line is arranged following a flip-chip packaging technique.
13. The chip according to any of the preceding items, wherein the at least one contact line is connected to a multiplexer chip.
14. The chip according to item 13, wherein the multiplexer is located in a separate region adjacent to the device regions.
15. The chip according to item 14, wherein the multiplexer chip is connected to a control computing unit.
16. The chip according to any of the preceding items, wherein each device region comprises a surface of at least 1 mm², preferably at least 10 mm², more preferably at least 50 mm².
17. The chip according to any of the preceding items, wherein the device regions are fabricated on a substrate.
18. The chip according to item 17, wherein the substrate is selected from the group of semiconducting materials such as InAs, InP, InSb, GaAs, GaSb, AISb and InGaAs, and/or group IV elements such as Si and/or Ge, and/or dielectric materials such as sapphire.
19. The chip according to item 18, wherein the substrate comprises a surface area of at least 5 mm², preferably at least 25 mm², more preferably at least 1 cm².
20. The chip according to any of the preceding items, wherein the identical devices are separated by less than 50 μm, preferably less than 10 μm and more preferably less than 5 μm.
21. The chip according to any of the preceding items, wherein the identical devices requiring a magnetic field are separated preferably less than 50 μm, more preferably less than 10 μm, even more preferably less than 5 μm.
22. The chip according to any of the preceding items, wherein the smallest distance between contact lines is at least 50 nm, preferably at least 100 nm or more preferably at least 300 nm.
23. The chip according to any of the preceding items, wherein the chip comprises resistive connections configured to protect the chip from electrostatic discharges.
24. The chip according to item 23, wherein the resistive connections comprise at least one a temperature dependent resistive layer.
25. The chip according to any of the preceding items, wherein the chip comprises at least one protective diode configured to protect the chip from electrostatic discharges.
26. The chip according to item 25, wherein the protective diode is lithographically designed on each device comprising the chip.
27. The chip according to items 25-26, wherein the protective diode is located on one end of each contact line.
28. The chip according to any of the preceding items, wherein the chip is assembled on a chip holder.
29. The chip according to item 28, wherein the chip holder is a printed circuit board.
30. The chip according to items 28-29, wherein the chip holder board comprises at least one element configured to protect the chip from electrostatic discharges.
31. A method of performing quantum experiments on a chip for educational purposes, comprising the steps of:
   a. providing one or more quantum lab chips according to any of the preceding items,
   b. cooling down the chip to a target cryogenic temperature,
   c. measuring a number of devices located within the same region,
   d. optionally, obtaining statistical deviations of the measured properties by measuring identical devices, and
   e. repeating step c, and optionally step d, in devices from at least one other region,
wherein optionally each measurement of devices in a particular region is performed on devices requiring similar physical conditions.
32. The method according to item 31, wherein the target cryogenic temperature is selected according to predefined requirements of the quantum experiment devices, such as room temperature, 77 K, 4 K or less than 1 K.
33. The method according to items 31-32, wherein measuring identical devices require similar physical conditions, such as a constant magnetic field, a variable magnetic field or a predefined temperature.

1. A quantum lab chip for quantum experiments, comprising a plurality of different device regions, each device region comprising quantum electronic devices requiring similar experimental conditions, wherein
a. at least a first device region comprises at least one semiconductor device, selected from the group of: field effect transistor, Drude conductivity, two-dimensional electron gas in heterostructure, one dimensional ballistic transport, quantum point contact, Coulomb blockade, single-electron transistors, single-electron turnstile, Aharonov Bohm effect, electron weak localization, electron antilocalization, coupled quantum dots, single-electron charge sensing, single-electron tunnelling, sequential electron tunnelling, Pauli blockade, spin-to-charge conversions, automatic gate-voltage tuning or spin qubits, and wherein
b. at least a second device region comprises at least one superconductor on insulator device, selected from the group of: superconducting microwave resonator, superconductor-insulator-superconductor Josephson junction, Meissner effect device, superconductor-insulator-normal metal junction, Fraunhofer interference device, SQUID device, or one or more superconducting qubits embedded in a microwave resonator.

2. The chip according to claim 1, wherein the chip comprises at least a third device region comprising at least one hybrid semiconductor-superconductor device.

3. The chip according to claim 1, wherein at least one of the device regions comprises a plurality of identical or at least similar devices.

4. The chip according to claim 1, wherein each device region is separated from each other a distance of at least 10 μm, or at least 100 μm, or more than 1 mm.

5. The chip according to claim 1, wherein each device region comprises at least one contact line connecting each device arranged following a flip-chip packaging technique.

6. The chip according to claim 5, wherein the at least one contact line is connected to a multiplexer chip located in a separate region adjacent to the device regions.

7. The chip according to claim 6, wherein the multiplexer chip is connected to a communication control unit.

8. The chip according to claim 1, wherein each device region comprises a surface of at least 1 mm², or at least 10 mm², or at least 50 mm².

9. The chip according to claim 1, wherein the device regions are fabricated on a substrate selected from the group of semiconducting materials: InAs, InP, InSb, GaAs, GaSb, AlSb and/or InGaAs, and/or from group IV elements Si and/or Ge, and/or dielectric materials.

10. The chip according to claim 1, wherein the identical devices are separated by less than 50 μm, or less than 10 μm and or less than 5 μm.

11. The chip according to claim 1, wherein the chip comprises resistive connections configured to protect the chip from electrostatic discharges.

12. The chip according to claim 1, wherein the chip is assembled on a chip holder, the chip holder comprising at least one element configured to protect the chip from electrostatic discharges.

13. A method of performing quantum experiments on a chip for educational purposes, comprising the steps of:
a. providing one or more quantum lab chips according to claim 1,
b. cooling down the chip to a target cryogenic temperature,
c. measuring a number of devices located within the same region, and
d. repeating step c in at least one device from at least one other region,
wherein each measurement of devices is performed on devices requiring similar physical conditions.

14. The method according to claim 13, wherein the target cryogenic temperature is selected according to predefined requirements of the quantum experiment devices.

15. The method according to claim 13, wherein measuring identical devices require similar physical conditions.

16. The method according to claim 15, wherein similar physical conditions are selected from the group of: constant magnetic field, variable magnetic field and a predefined temperature.

17. The chip according to claim 2, wherein the at least one hybrid semiconductor-superconductor device is an Andreev reflection or a topological superconductivity device.

18. The chip according to claim 3, wherein the plurality of identical or at least similar devices are at least 5, 10, or 100.

19. The chip according to claim 11, wherein the resistive connections are at least one temperature dependent resistive layer or a diode configured to protect the chip from electrostatic discharges.

20. The chip according to claim 12, wherein the chip holder is a printed circuit board.

21. The method according to claim 14, wherein predefined requirements of the quantum experiment devices are selected from the group of: room temperature, 77 K, 4 K, and less than 1 K.
